(19) United States
(12) Patent Application Publication
(10) Pub. No.: US 2017/0134815 A1
(43) Pub. Date: May 11, 2017

(54) SYSTEMS FOR CREATING AND DISTRIBUTING VIDEOS OF REAL ESTATE

(71) Applicants: Joshua LOMELINO, Franklin, TN (US); Michael JOHNSON, Smyrna, TN (US)

(72) Inventors: Andrew CREFELD, Mt. Juliet, TN (US); Joshua LOMELINO, Franklin, TN (US); Michael JOHNSON, Smyrna, TN (US)

(21) Appl. No.: 15/311,801

(22) PCT Filed: May 6, 2016
(86) PCT No.: PCT/US16/31275

§ 371 Date: Nov. 16, 2016

Related U.S. Application Data
(60) Provisional application No. 62/157,545, filed on May 6, 2015.

(51) Int. Cl. H04N 21/478; H04N 21/854; H04N 21/222; G06Q 50/16; H04N 21/4627; H04N 21/2343; H04N 21/858; H04N 21/61; H04N 21/254

(52) U.S. Cl. CPC H04N 21/47815; H04N 21/6125; H04N 21/85406; H04N 21/222; H04N 21/2541; H04N 21/4627; H04N 21/234309; H04N 21/8586; G06Q 50/163

(57) ABSTRACT

In one embodiment, a system for creating and distributing videos of a real estate property includes a mobile device, a first cloud storage system, a server system, and a second cloud storage system. The mobile device may include a camera, a microprocessor, a display, and a software application installed on the mobile device. The software application may be programmed to uniquely identify a user via login credentials, guide the user to create and edit a first video file of the real estate property, associate the first video file with the user via a unique user ID related to the login credentials, and upload the first video file to a first cloud storage system. The first video may be created in a first file format. The first cloud storage system may be configured to store the first video in the first file format according to the unique user ID, and download the first video file and associated unique user ID to a server system. The server system may be configured to convert the first video file to at least a second file format, thereby creating a second video file. The server system may further be configured to upload the second video in the second file format to a second cloud storage system, and automatically send the user a link to the second video. The second cloud storage system may be configured to store the second video file according to the unique user ID.

### CROSS REFERENCE TO RELATED APPLICATIONS

This application claims priority to U.S. Provisional Application Ser. No. 62/157,545 entitled REAL ESTATE VIDEO RECORDING AND DISTRIBUTION SYSTEM, filed on May 6, 2015, which is hereby incorporated by reference for all purposes.

### BACKGROUND

The present disclosure relates generally to systems for creating and distributing video of real estate. In particular, systems for creating and distributing video of real estate simply and easily via mobile device are described.

Known video systems are not entirely satisfactory for the range of applications in which they are employed in real estate. For example, existing systems lack a simple and/or automatic method to provide the real estate videos in both branded and unbranded forms. Unbranded video access may be required in order to comply with requirements of real estate listing services, such as the MLS (Multiple Listing Service).

In addition, conventional video systems may lack the ability to create and compile video clips of real estate into a virtual walkthrough.

Thus, there exists a need for systems for creating and distributing video of real estate that improve upon and advance the design of known video systems. Examples of new and useful systems for creating and distributing video of real estate relevant to the needs existing in the field are discussed below.

### SUMMARY

In one embodiment, a system for creating and distributing videos of a real estate property includes a mobile device, a first cloud storage system, a server system, and a second cloud storage system. The mobile device may include a camera, a microprocessor, a display, and a software application installed on the mobile device. The software application may be programmed to uniquely identify a user via login credentials, guide the user to create and edit a first video file of the real estate property, associate the first video file with the user via a unique user ID related to the login credentials, and upload the first video file to a first cloud storage system. The first video may be created in a first file format. The first cloud storage system may be configured to store the first video in the first file format according to the unique user ID, and download the first video file and associated unique user ID to a server system. The server system may be configured to convert the first video file to at least a second file format, thereby creating a second video file. The server system may further be configured to upload the second video in the second file format to a second cloud storage system, and automatically send the user a link to the second video. The second cloud storage system may be configured to store the second video file according to the unique user ID.

In one embodiment, the second cloud storage system may be configured to provide the second video file to a content delivery network for streaming the second video file. In one embodiment, the server system comprises an encoder, wherein the server system converts the first video file to at least the second file format via the encoder. In one embodiment, the server system comprises a notifier, wherein the server system automatically sends the user a link to the second video via the notifier. The notifier may be configured to send one or more push notifications related to a status of the first video file to the mobile device.

In one embodiment, the server system comprises a web server, wherein the web server is configured to provide at least the second video file to a first unbranded webpage and a first branded webpage. The unbranded web page may be free of advertising and free of links to third-party webpages, in compliance with Multiple Listing Service (MLS) listing rules.

In one embodiment, a system for creating and distributing videos of a real estate property system comprises a database, wherein the database is configured to store at least the second video file.

In one embodiment, the software application installed on the mobile device may comprise a video stabilizer configured to reduce shakiness in the first video file due to movement of the user when recording the first video file.

In one embodiment, the server system is programmed to automatically upload the second video file to one or more third party websites.

In one embodiment, the software application is downloaded via the internet from an application store. In one embodiment, the unique user ID is associated with an email address of the user.

In one embodiment, the server system is programmed to send the user the link to the second video via the email address of the user.

In some embodiments, the mobile device comprises a 3D sensor. In these embodiments, the software application is programmed to guide the user to create a 3D model of at least a portion of the real estate property, associate the first video file and the 3D model with the user via a unique user ID related to the login credentials, and upload the first video file and the 3D model to a first cloud storage system. The server system may be configured to automatically send the user links to the second video and the 3D model.

### BRIEF DESCRIPTION OF THE DRAWINGS

FIG. 1 is a schematic illustration of a first example of a system for creating and distributing videos of real estate.

FIG. 2 is a schematic illustration of a server system in accordance with the present disclosure.

FIG. 3 is a schematic illustration of a mobile device in accordance with the present disclosure.

FIG. 4A is a view of a first user interface page of software of the mobile device of FIG. 3, showing a video clip of a portion of a real estate property being created.

FIG. 4B is a view of the first user interface page, showing the video clip being edited.

FIG. 4C is a view of the first user interface page, showing the video clip being saved.

FIG. 4D is a view of the first user interface page, showing the video clip being labeled.

FIG. 5A is a view of a second user interface page of software of the mobile device, showing the video clip of FIG. 4a being loaded into a predetermined menu of clips comprising a virtual walkthrough of the real estate property.

FIG. 5B is a view of the second user interface page, showing a schematic overview of the real estate property.

FIG. 5C is a view of a third user interface page, showing feedback information related to the virtual walkthrough of FIG. 5a, as served to a branded and/or unbranded webpage.

FIG. 5D is a view of the third user interface page, showing a user's library of virtual walkthroughs including feedback information related to each virtual walkthrough, as served to a branded and/or unbranded webpage.

### DETAILED DESCRIPTION

The disclosed systems for creating and distributing videos of real estate will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems for creating and distributing videos of real estate are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

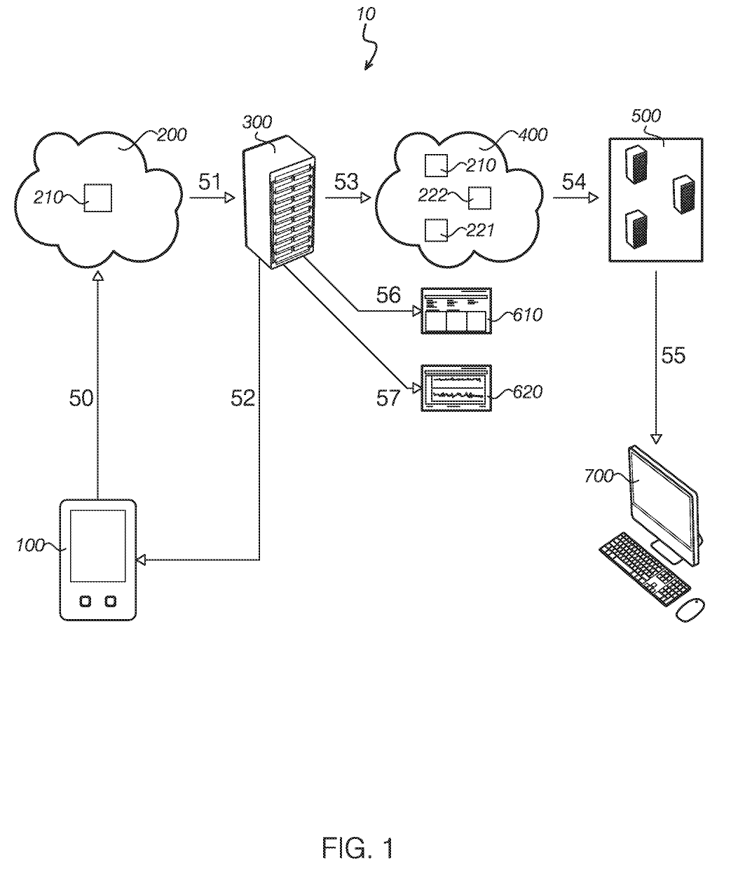

With reference to FIGS. 1-5D, a first example of a system for creating and distributing videos of real estate, system 10, will now be described. System 10 includes a mobile device 100, a first cloud storage system 200, a server system 300, a second cloud storage system and a content delivery network 500. In one embodiment, system 10 functions to assist a user in creating and editing one or more virtual walkthroughs of real estate simply and easily, then automatically store, convert, and provide those walkthroughs to various content viewing portals. The content viewing portals may include branded websites (e.g., a real estate agent's website) and unbranded websites, such unbranded websites being suitable for Multiple Listing Service (MLS) listings.

Turning now to FIG. 1, a first embodiment of a system for creating and distributing videos of real estate, system 10, is shown. In the illustrated embodiment, one or more video clips of a real estate property may be recorded via mobile device 100. The clip(s) may then be edited together to create a virtual walkthrough of the real estate property embodied in a first video file 210. A unique user ID may be associated with first video file 210.

First video file 210 and the associated unique user ID may then be uploaded via internet pathway 50 to first cloud storage system 200. First cloud storage system 200 is configured to automatically store first video file 210, in a first file format, and according to the unique user ID. First cloud storage system 200 is further configured to automatically download first video file 210 to server system 300 via pathway 51. In one embodiment first cloud storage system 200 may comprise a third party cloud storage service such as, for example, AMAZON S3.

Server system 300 is configured to convert first video file 210 from the first file format to at least a second file format, thereby creating a second video file 220. In some embodiments, server system 300 may further convert first video file 210 to third file format, thereby creating a third video file 221. In some embodiments, server system 300 may further convert first video file 210 to fourth file format, thereby creating a fourth video file 222, and so on.

Server system 300 is further configured to provide the one or more converted video files 220, 221, and/or 222 to one or more unbranded websites 610, via pathway 56. As used herein “unbranded websites” means websites free of advertising and free of links to external websites that contain advertising. In this regard, links to the unbranded website(s) may be included in online MLS listings. Server system 300 may also be configured to automatically provide the one or more converted video files 220, 221, and/or 222 to one or more branded websites 620 via pathway 57. Branded websites may contain contact information, photos, logos, watermarks, etc. of, for example, the listing agent. Thus, the virtual walkthrough may be automatically provided to a plurality of viewing portals, including branded and unbranded websites, in the form of displaying converted video files 220, 221, and/or 222.

Server system 300 may further be configured to automatically send notifications, for example push notifications, related to the status of the first video file 210 and/or converted video files 220, 221, and/or 222. In one embodiment, server system 300 may automatically send the user a link to the relevant video file and/or link to the branded/unbranded website. In one embodiment, the link may be sent to mobile phone 100 via pathway 52.

In some embodiments, server system 300 is further configured to upload the converted video files 220, 221, and/or 222 to a second cloud storage system 400 via pathway 53. Second cloud storage system 400 is configured to store the converted video files 220, 221, and/or 222. Cloud storage system 400 may also provide links to branded/unbranded website and/or converted video files 220, 221, and/or 222 to one or more content delivery networks 500, via pathway 54.

Content delivery network(s) 500 may function to cache the converted video files 220, 221, and/or 222 in locations near an end user device 700. Thus, content delivery network(s) 500 may facilitate improved streaming of converted video files 220, 221, and/or 222, via pathway 55.

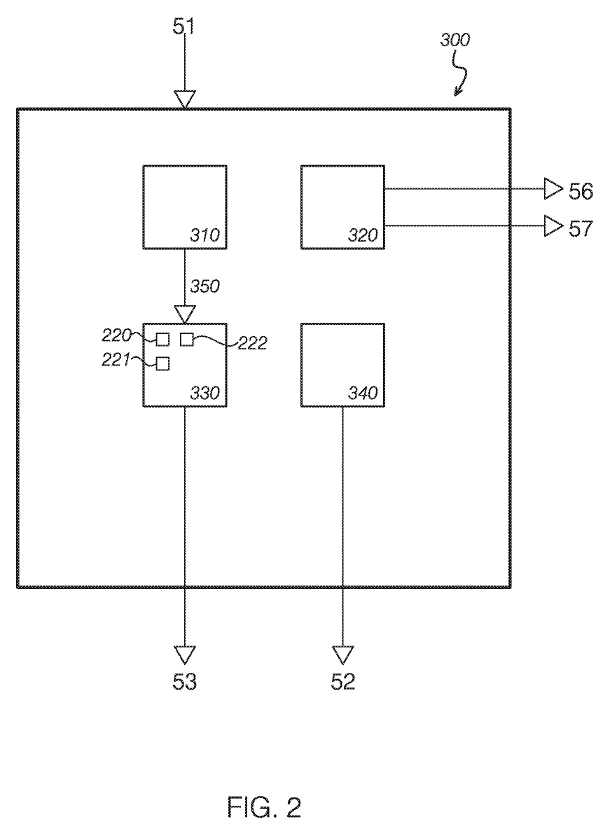

Turning now to FIG. 2, a schematic illustration of one embodiment of server system 300 is shown. In the illustrated embodiment, server system 300 includes an encoder 310, a web server 320, a database 330, and a notifier 340. Encoder 310 is configured to convert first video file 210 to converted video files 220, 221, and/or 222 by converting the first file type to the second, third, and/or fourth etc. file type.

Web server 320 is configured to provide the converted video files 220, 221, and/or 222 to unbranded websites 610 via pathway 56 and/or branded/unbranded websites 620 via path 57. Database 330 is configured to store the location of one or more of video files 210, 220, 221, 222 in the system storage. Once stored in database 330, the video files may be uploaded to second cloud storage system 400 via pathway 53.

Notifier 340 is configured to automatically send notifications, for example push notifications, related to the status of the first video file 210 and/or converted video files 220, 221, and/or 222. In one embodiment, notifier 340 may automatically send the user a link to the relevant branded/unbranded website and/or video file. In one embodiment, the link may be sent to mobile device 100 via pathway 52.

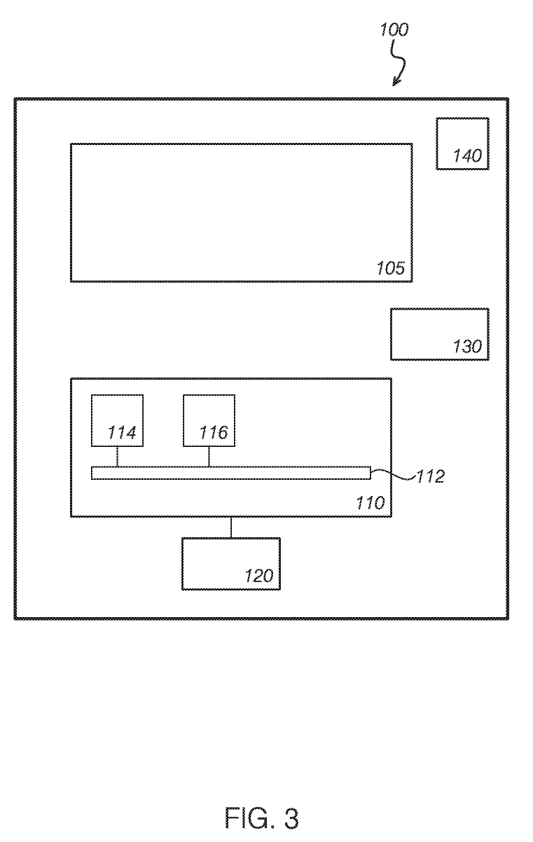

Turning now to FIG. 3, a schematic illustration of mobile device 100 is shown. In the illustrated embodiment, mobile device 100 includes a display 105, a camera 140, a memory 110, a microprocessor 120, an operating system 112, and software applications 114, 116 installed on mobile device 100. A user may interface with the device via display 105. Software application 114 may request a unique user ID during login via login credentials. In one embodiment, the login credentials may comprise an email address of the user.

In the illustrated embodiment, camera 140 may comprise a video camera for capturing video clips. Alternatively or additionally, in some embodiments camera 140 may comprise a still camera.

Software application 114 is programmed to guide the user through the process of creating and editing the first video file 210 of real estate property. In one embodiment, the user is prompted to record one or more video clips as the user moves throughout the real estate property. In one embodiment, software application 114 may include a video stabilizer. The video stabilizer may be configured to reduce shakiness in the clip(s). Such shakiness may be due to, for example, movement of mobile device 100 as a result of the user walking during recording of the video clip(s).

Mobile device 100 may optionally be connected to a 3D sensor 130. In some embodiments, 3D sensor 130 may be integral to mobile device 100. In other embodiments, 3D sensor 130 may be a separate device. In one embodiment, the 3D sensor may comprise one or more transmitters and one or more receivers of electromagnetic waves. The 3D sensor may be configured to calculate the distance to surfaces in the room via reflected electromagnetic waves.

In some embodiments, 3D sensor 130 in conjunction with software application 114 may be used to create a 3D model of at least a portion of the real estate property. Software application 114 may then associate the 3D model with the user via the unique user ID. Software application 114 may then upload the 3D model to first cloud storage system 200.

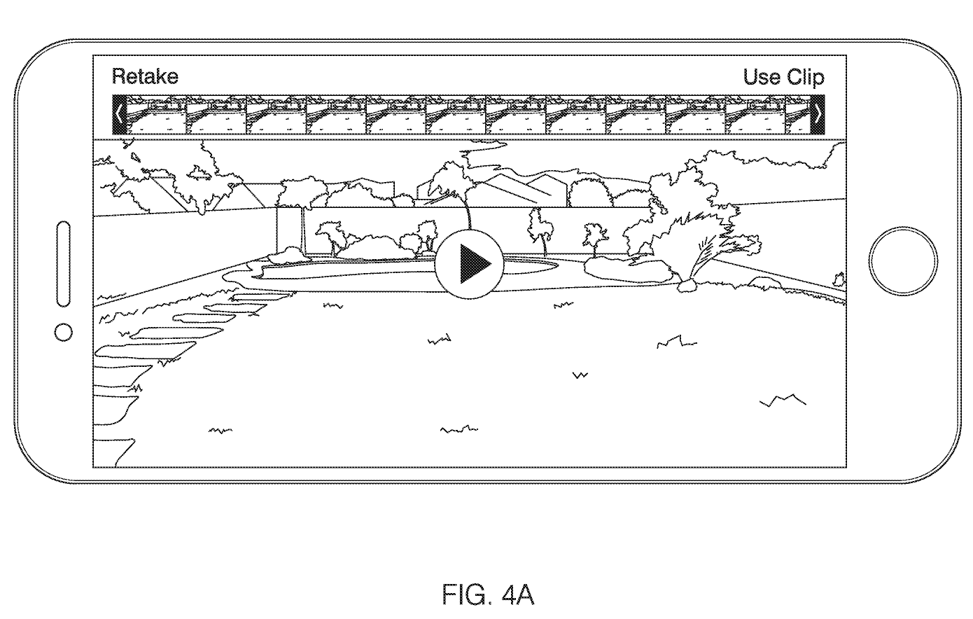

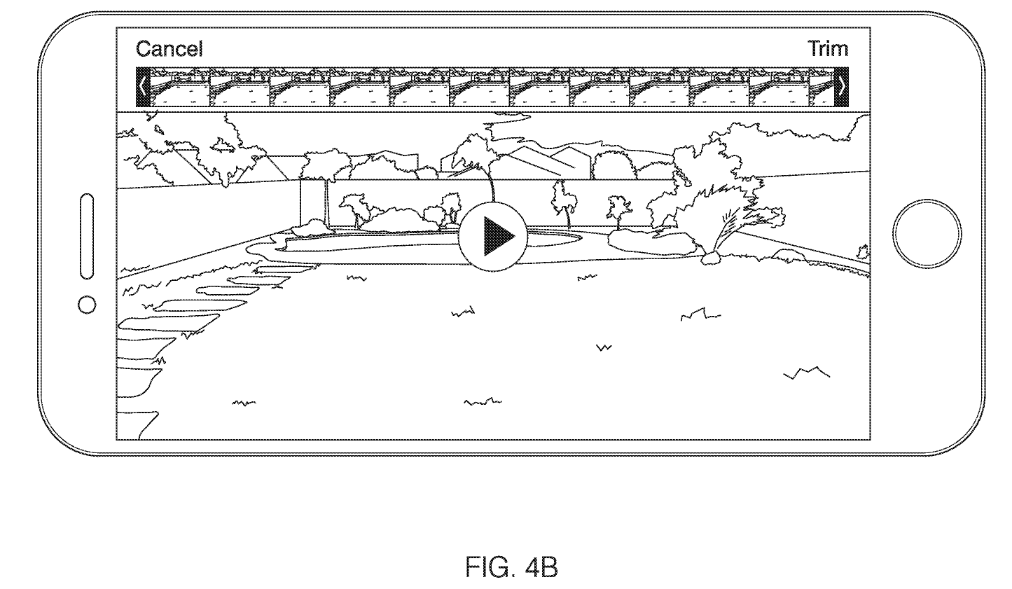

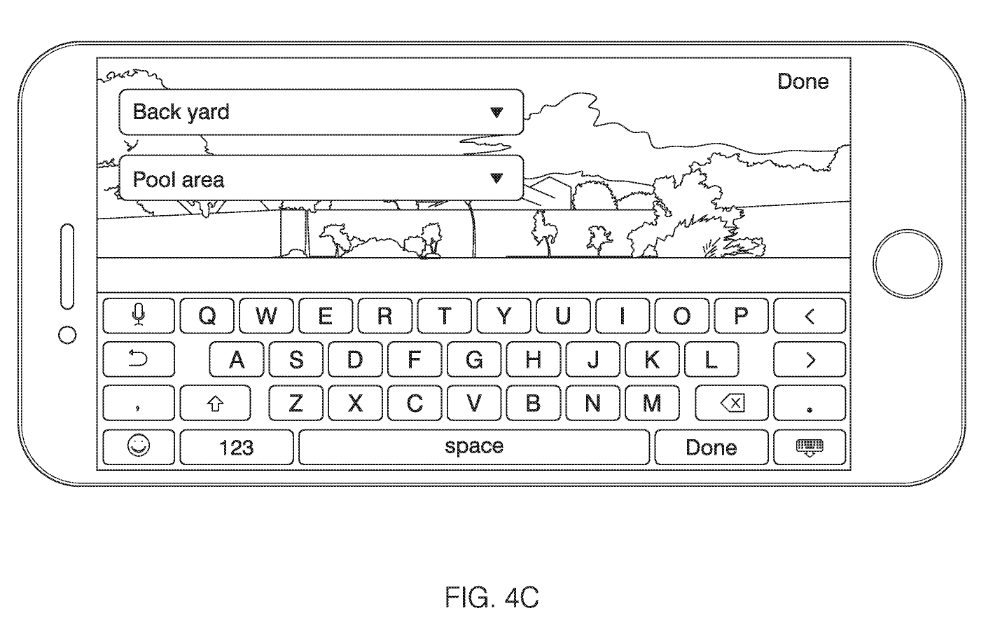

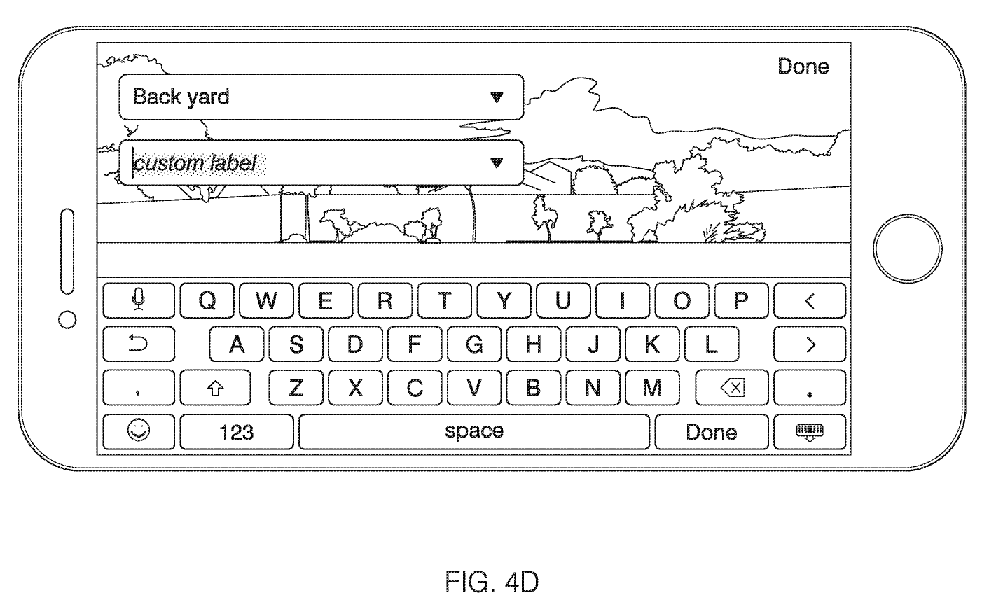

Turning now to FIG. 4A a view of a first user interface page of software application 114 running on mobile device 100 is shown. As can be seen, a video clip of a portion of a real estate property has been recorded. Software application 114 presents the user with the option to retake the clip or use the clip.

Turning now to FIG. 4B, a second view of the first user interface page is shown. Once the clip has been recorded, software application 114 allows the user to edit the clip. For example, as can be seen in FIG. 4B, the clip may be trimmed for length.

Turning now to FIG. 4C, a third view of the first user interface page is shown. As can be seen, once the video clip has been created and edited, the video clip may be saved. Software application 114 may include predetermined labels for the video clips. The predetermined labels may be used to construct the virtual walkthrough.

Turning now to FIG. 4D, a fourth view of the first user interface page is shown. As can be seen, software application 114 includes the option to generate a custom label for the video clip.

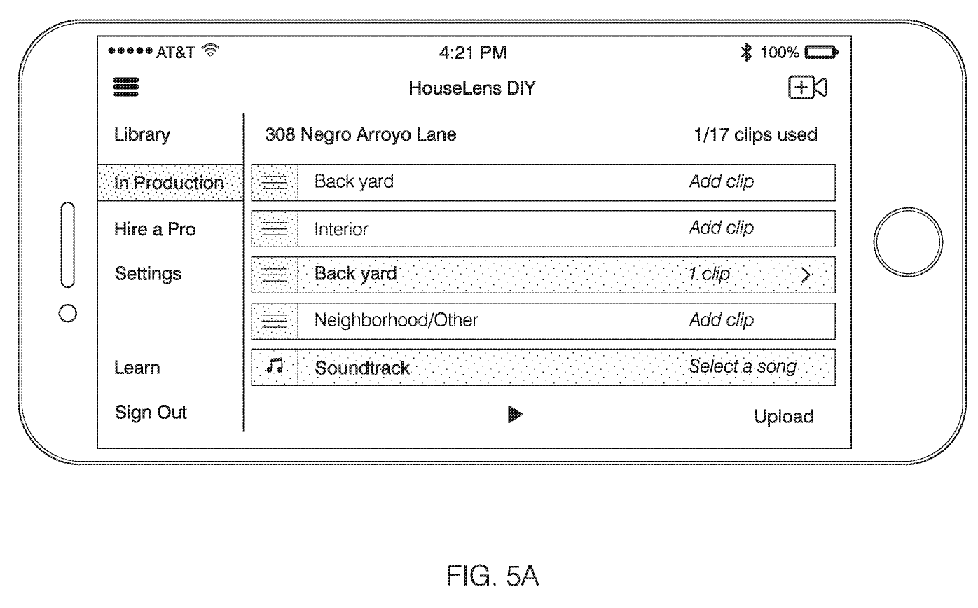

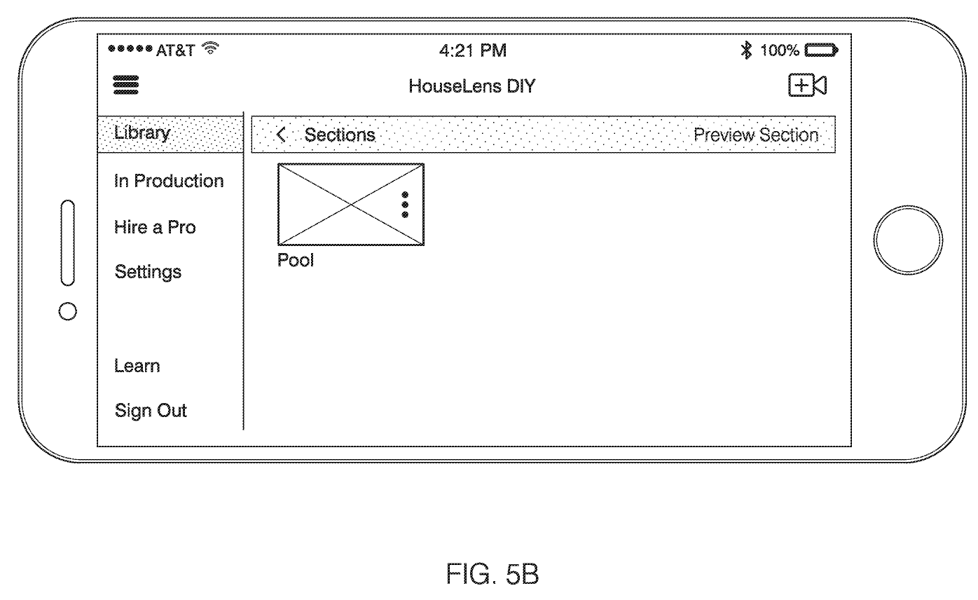

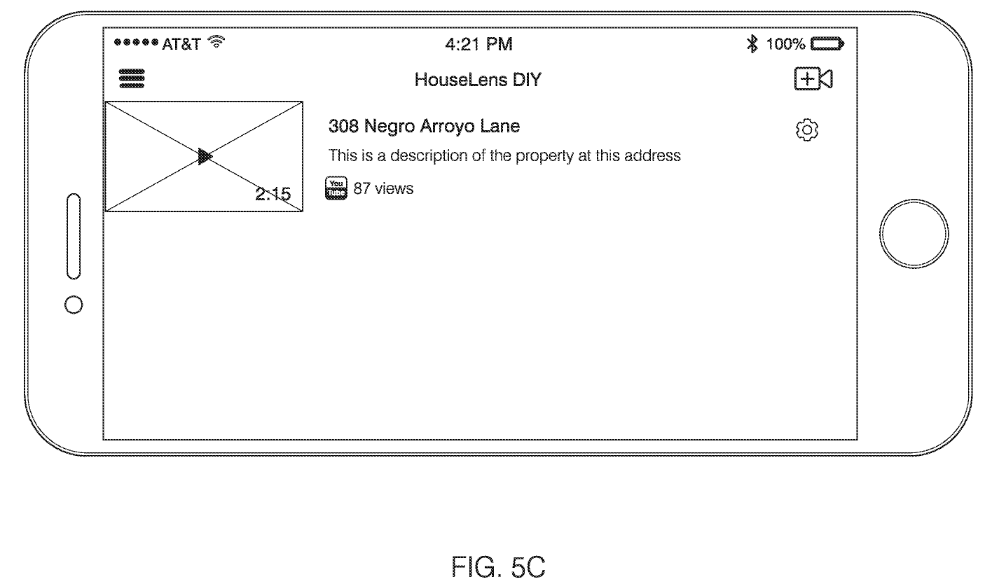

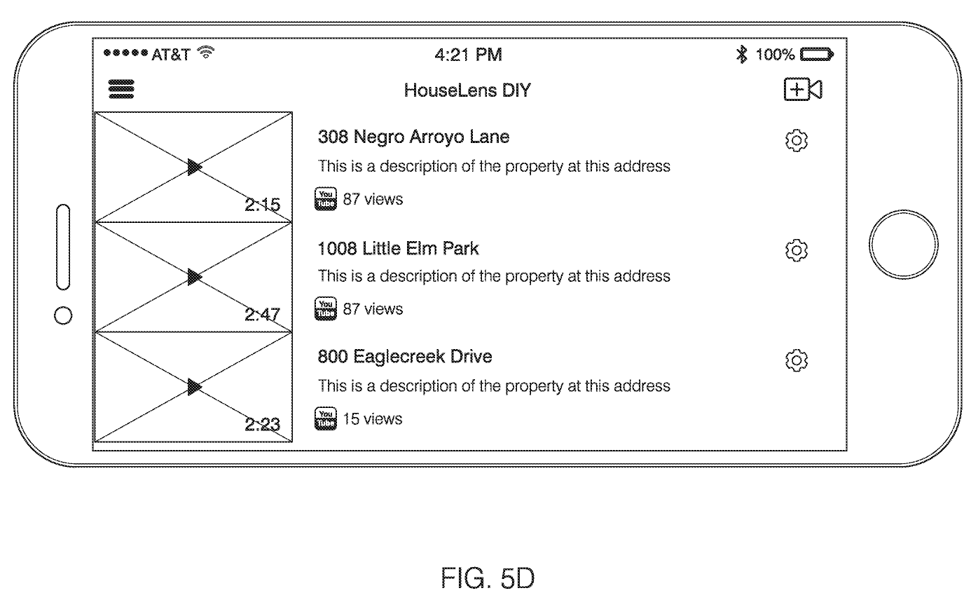

Turning now to FIG. 5A, a first view of a second user interface page of software application 114 running on mobile device 100 is shown. As can be seen, software application 114 includes a predetermined menu of clip labels. The predetermined menu may organize the clips by areas of the real estate property. In this regard, the predetermined menu may facilitate creation of a virtual walkthrough of the real estate property via the video clips. Furthermore as can be seen in FIG. 5A, the predetermined menu may allow the user to add a music soundtrack to the virtual walkthrough

Turning now to FIG. 5B, a second view of the second user interface page is shown. As can be seen, software application 114 may include a schematic overview of the real estate property.

Turning now to FIG. 5C, a first view of a third user interface page is shown. As can be seen, software application 114 may include feedback information related to the virtual walkthrough as served to a branded/unbranded webpage. In the illustrated embodiment, the feedback information includes the number of times the virtual walkthrough has been viewed via the branded/unbranded webpage.

Turning now to FIG. 5D, a second view of the third user interface page is shown. As can be seen, software application 114 may include a user library of virtual walkthroughs including feedback information related to each virtual walkthrough, as served to a branded/unbranded webpage.

In other embodiments (not pictured), the software application may be configured to facilitate a live virtual showing. In this regard, a video walkthrough of the real estate property may be uploaded to the first cloud storage system as it is recorded via the mobile device. Thus, one or more viewers may view the live virtual showing remotely in real time or from an archived copy for later viewing.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for creating and distributing videos of a real estate property, the system comprising:
(a) a mobile device comprising:
(i) a camera;
(ii) a microprocessor;
(iii) a display; and
(iv) a software application installed on the mobile device, wherein the software application is programmed to:
(1) uniquely identify a user via login credentials;
(2) guide the user to create and edit a first video file of the real estate property, wherein the first video is created in a first file format;
(3) associate the first video file with the user via a unique user ID related to the login credentials; and
(4) upload the first video file to a first cloud storage system;
(b) the first cloud storage system, wherein the first cloud storage system is configured to:
(i) store the first video in the first file format, wherein the first video file is stored according to the unique user ID; and
(ii) download the first video file and associated unique user ID to a server system;
(c) the server system, wherein the server system is configured to:
(i) convert the first video file to at least a second file format, thereby creating a second video file;
(ii) upload the second video in the second file format to a second cloud storage system, wherein the second video file is stored according to the unique user ID;
(iii) automatically send the user a link to the second video; and
(d) the second cloud storage system, wherein the second cloud storage system is configured to:
(i) store the second video file according to the unique user ID.

2. The system of claim 1, wherein the second cloud storage system is configured to provide the second video file to a content delivery network for streaming the second video file.

3. The system of claim 1, wherein the server system comprises an encoder, wherein the server system converts the first video file to at least the second file format via the encoder.

4. The system of claim 1, wherein the server system comprises a notifier, wherein the server system automatically sends the user a link to the second video via the notifier.

5. The system of claim 3, wherein the notifier is configured to send one or more push notifications related to a status of the first video file to the mobile device.

6. The system of claim 1, wherein the server system comprises a web server, wherein the web server is configured to provide at least the second video file to:
a first unbranded webpage; and
a first branded webpage.

7. The system of claim 6, wherein the unbranded web page is free of advertising and free of links to third-party webpages, in compliance with Multiple Listing Services (MLS) listing rules.

8. The system of claim 1 comprising a database, wherein the database is configured to store at least the second video file.

9. The system of claim 1, wherein the software application installed on the mobile device comprises a video stabilizer configured to reduce shakiness in the first video file do to movement of the user when recording the first video file.

10. The system of claim 1, wherein the server system is programmed to automatically upload the second video file to one or more third party websites.

11. The system of claim 1, wherein the software application is downloaded via the internet from an application store.

12. The system of claim 1, wherein the unique user ID is associated with an email address of the user.

13. The system of claim 5, wherein the server system is programmed to send the user the link to the second video via the email address of the user.

14. A system for creating and distributing videos of a real estate property, the system comprising:
(a) a mobile device comprising:
(i) a camera;
(ii) a microprocessor;
(iii) a display;
(iv) a 3D sensor; and
(v) a software application installed on the mobile device, wherein the software application is programmed to:
(1) uniquely identify a user via login credentials;
(2) guide the user to create and edit a first video file of the real estate property, wherein the first video is created in a first file format;
(3) guide the user to create a 3D model of at least a portion of the real estate property;
(4) associate the first video file and the 3D model with the user via a unique user ID related to the login credentials; and
(5) upload the first video file and the 3D model to a first cloud storage system;
(b) the first cloud storage system, configured to:
(i) store the first video in the first file format, wherein the first video file is stored according to the unique user ID; and
(ii) download the first video file and associated unique user ID to a server system;
(c) the server system, configured to:
(i) convert the first video file to at least a second file format, thereby creating a second video file;
(ii) upload the second video in the second file format to a second cloud storage system, wherein the second video file is stored according to the unique user ID;
(iii) automatically send the user links to the second video and the 3D model.

15. The system of claim 14, wherein the server system comprises a web server, wherein the web server is configured to serve at least the second video file to:
a first unbranded webpage; and
a first branded webpage.
